(19) United States
(12) Patent Application Publication
(10) Pub. No.: US 2005/0179266 A1
(43) Pub. Date: Aug. 18, 2005

(54) Interconnected chassis for a lock set

(76) Inventor: Oscar Romero, Lake Forest, CA (US)

Correspondence Address: Ronald K. Aust;Taylor & Aust, P.C., 12029 E. Washington Street, Indianapolis, IN, 46229, US

(21) Appl. No.: 10/780,189

(22) Filed: Feb. 17, 2004

(51) Int. Cl. E05C 5/00

(52) U.S. Cl. 292/336.3

(57) ABSTRACT

An interconnected chassis for a lock set includes a mounting plate having a first guide channel, a second guide channel spaced apart from the first guide channel, and a spring engaging member. A lower cam arm, having a lower rotational axis, is rotatably coupled to the mounting plate. A slide plate has a spring retention wall and a spring engaging surface. The slide plate is positioned between, and in sliding engagement with, the first guide channel and the second guide channel, and is positioned above the lower cam arm. A spring retention chamber is established between the spring retention wall of the slide plate and the mounting plate. The spring retention chamber provides lateral containment of a spring. The spring is positioned in the spring retention chamber between the spring engaging member of the mounting plate and the spring engaging surface of the slide plate.

### BACKGROUND OF THE INVENTION

1. Field of the Invention

The present invention relates to door hardware, and, more particularly, to an interconnected chassis for a lock set.

2. Description of the Related Art

Lock sets have long been available that include an interconnected lock assembly, wherein actuation of an interior operator, e.g., knob or lever, simultaneously retracts both a latch bolt and a dead bolt. Such a lock assembly may be found in both commercial and residential environments. In one such lock set, a series of gears, e.g., a rack, is used to effect the simultaneous operation.

In another such lock set, for example, a slide is positioned between the actuation mechanism of the operator and the actuation mechanism of a turn piece connected to the dead bolt, wherein the slide may be spring biased in a plane of travel of the slide. Assembly of such a lock set, however, may be complicated by including chassis components that are riveted together.

Furthermore, some lock sets may be limited by their configuration to a particular escutcheon and/or operator, and thus, limit a customer to a particular escutcheon design and/or operator type.

What is needed in the art is an interconnected chassis for a lock set that addresses the above-identified problems.

### SUMMARY OF THE INVENTION

The invention, in one form thereof, is directed to an interconnected chassis for a lock set. The interconnected chassis includes a mounting plate including a first guide channel, a second guide channel spaced apart from the first guide channel, and a spring engaging member. A lower cam arm, having a lower rotational axis, is rotatably coupled to the mounting plate. A slide plate has a spring retention wall and a spring engaging surface. The slide plate is positioned between, and in sliding engagement with, the first guide channel and the second guide channel, and is positioned above the lower cam arm. A spring retention chamber is established between the spring retention wall of the slide plate and the mounting plate. The spring retention chamber provides lateral containment of a spring. The spring is positioned in the spring retention chamber between the spring engaging member of the mounting plate and the spring engaging surface of the slide plate.

In another form thereof, the invention is directed to a method for providing an interconnected chassis for a lock set, comprising the steps of configuring a mounting plate including a first guide channel, a second guide channel spaced apart from the first guide channel, and a spring engaging member; rotatably coupling a lower cam arm, having a lower rotational axis, to the mounting plate; configuring a slide plate having a spring retention wall and a spring engaging surface; positioning the slide plate between, and in sliding engagement with, the first guide channel and the second guide channel, and above the lower cam arm; and establishing a spring retention chamber between the spring retention wall of the slide plate and the mounting plate, the spring retention chamber providing lateral containment of a spring, the spring being positioned in the spring retention chamber between the spring engaging member of the mounting plate and the spring engaging surface of the slide plate.

In another form thereof, the invention is directed to a lock set with an interconnected chassis. A mounting plate has a first guide channel, a second guide channel spaced apart from the first guide channel, and a first spring engaging member. A first cam arm, having a first rotational axis, is rotatably coupled to the mounting plate. A second cam arm, having a second rotational axis, is rotatably coupled to the mounting plate. A slide plate includes a first cam arm engagement member, a second cam arm engagement member, and an interior region located between the first cam arm engagement member and the second cam arm engagement member. The interior region of the slide plate has a first spring retention wall and a first spring engaging surface. The slide plate is positioned between, and in sliding engagement with, the first guide channel and the second guide channel of the mounting plate. A first spring retention chamber is established between the first spring retention wall of the slide plate and the mounting plate. The first spring retention chamber provides lateral containment of a first compression spring. The first compression spring is positioned in the first spring retention chamber between the first spring engaging member of the mounting plate and the first spring engaging surface of the slide plate.

In another form thereof, the invention is directed to a method for providing a lock set with an interconnected chassis. The method includes the steps of configuring a mounting plate for attachment to a door, the mounting plate having a first guide channel, a second guide channel spaced apart from the first guide channel, and a first spring engaging member; rotatably coupling a first cam arm, having a first rotational axis, to the mounting plate; rotatably coupling a second cam arm, having a second rotational axis, to the mounting plate; forming a slide plate having a first cam arm engagement member, a second cam arm engagement member, and an interior region located between the first cam arm engagement member and the second cam arm engagement member, the interior region of the slide plate having a first spring retention wall and having a first spring engaging surface; positioning the slide plate between, and in sliding engagement with, the first guide channel and the second guide channel; establishing a first spring retention chamber between the first spring retention wall of the slide plate and the mounting plate, the first spring retention chamber providing lateral containment of a first compression spring; and positioning the first compression spring in the first spring retention chamber, and between the first spring engaging member of the mounting plate and the first spring engaging surface of the slide plate.

In still another form thereof, the invention is directed to an interconnected chassis for a lock set. A mounting plate is configured for attachment to a door, the mounting plate including a first opening and a second opening vertically spaced apart from the first opening, a first guide channel and a second guide channel horizontally spaced apart from the first guide channel, and at least a first spring engaging member. A first cam arm has a first rotational axis, and is rotatably coupled to the mounting plate at the first opening. A second cam arm has a second rotational axis, and is rotatably coupled to the mounting plate at the second opening. A slide plate has a first end, a second end, and an interior region between the first end and the second end. The slide plate is positioned between, and in sliding engagement with, the first guide channel and the second guide channel of the mounting plate. The slide plate includes a first cam arm engagement member located at the first end of the slide plate and a second cam arm engagement member located at the second end of the slide plate. The interior region of the slide plate has at least a first spring retention housing. The first spring retention housing has a first elongated cavity defined by a first spring retention wall and has a first spring engaging surface. The first elongated cavity of the slide plate cooperates with the mounting plate to define a first spring retention chamber that provides lateral containment and support of a first compression spring. The first compression spring is positioned between the first spring engaging member of the mounting plate and the first spring engaging surface of the slide plate. The first compression spring biases the second cam arm engagement member of the slide plate into engagement with the second cam arm.

An advantage of the present invention is that the interconnected chassis is relatively simple to assemble.

Another advantage is that the present invention provides for a more robust lock set design, such as for example, by providing an interconnected chassis that is not held together with rivets, and is configured to reduce the chance of unintended lateral spring displacement during operation.

Yet another advantage is that the interconnected chassis of the present invention is independent of the escutcheon and/or interior operator, and therefore can accommodate a variety of decorative escutcheons of various materials and ornamental features, and/or a variety of interior operator types.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is an exploded perspective view of an interconnected lock set embodying the present invention.

FIG. 2 is an exploded perspective view of the interconnected chassis embodied in FIG. 1.

FIG. 3A is a front view of the interconnected chassis of FIG. 2 with the slide plate and the lower cam arm in a rest position, and with the upper cam arm in an unlocked position, with a portion of the spring retention housings broken away to show the corresponding springs.

FIG. 3B is a front view of the interconnected chassis of FIG. 2 with the upper cam arm in a locked position, with a portion of the spring retention housings broken away to show the corresponding springs.

FIG. 3C is a front view of the interconnected chassis of FIG. 2, wherein a rotation of the lower cam arm causes the slide plate to engage and rotate the upper cam arm from the locked position toward an unlocked position, with a portion of the spring retention housings broken away to show the corresponding springs.

FIG. 3D is a front view of the interconnected chassis of FIG. 2 with the slide plate having rotated the upper cam arm to the unlocked position, with a portion of the spring retention housings broken away to show the corresponding springs.

FIG. 4 is a cross-sectional view of the interconnect chassis taken along line 4-4 of FIG. 3A.

Corresponding reference characters indicate corresponding parts throughout the several views. The exemplifications set out herein illustrate one embodiment of the invention, in one form, and such exemplifications are not to be construed as limiting the scope of the invention in any manner.

### DETAILED DESCRIPTION OF THE INVENTION

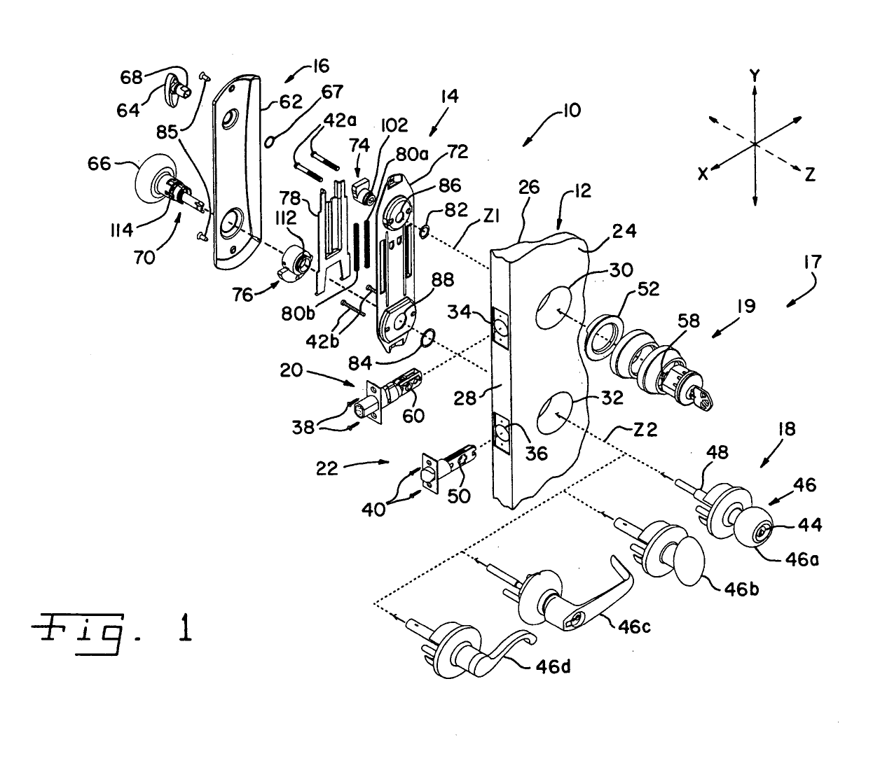

Referring now to the drawings, and more particularly to FIG. 1, there is shown a lock set 10 embodying the present invention, for mounting to a door 12. Lock set 10 includes, for example, an interconnected chassis 14; an interior operating unit 16; an exterior operating unit 17, including an exterior operator 18 and a dead bolt lock assembly 19; a dead bolt assembly 20; and a latch bolt assembly 22.

Door 12 includes an exterior side 24, an interior side 26, and an end 28. An upper bore 30 and a lower bore 32 are formed through door 12 from exterior side 24 to interior side 26. A dead bolt bore 34 is formed in door 12 from end 28 to upper bore 30. A latch bolt bore 36 is formed in door 12 from end 28 to lower bore 32.

During assembly, interconnected chassis 14 is positioned adjacent interior side 26 of door 12, and is interposed between interior operating unit 16 and exterior operating unit 17. Dead bolt assembly 20 is inserted into dead bolt bore 34 and attached to end 28 with two fasteners 38. Latch bolt assembly 22 is inserted into latch bolt bore 36 and attached to end 28 with two fasteners 40. Interconnected chassis 14 is attached to interior side 26 of door 12 with two fasteners 4a, which engage corresponding threaded holes in dead bolt lock assembly 19, and with two fasteners 42b which engage corresponding threaded holes in exterior operator 18.

FIG. 1 shows four exemplary configurations for exterior operator 18. Exterior operator 18 may include an operator lock assembly 44, and includes an exterior handle 46. Exterior handle 46 may be, for example, in a form having a knob, such as one of knobs 46a, 46b, or in a form having a lever, such as one of levers 46c, 46d.

Exterior operator 18 includes a drive portion 48, such as a half-round spindle. Drive portion 48 is inserted into lower bore 32 to engage a driven member 50 of latch bolt assembly 22.

Dead bolt lock assembly 19 includes a bushing 52 that is inserted into upper bore 30 from exterior side 24. Dead bolt lock assembly 19 further includes a drive member 58, which is inserted into bushing 52 and upper bore 30 to engage a driven member 60 of dead bolt assembly 20, and engages interconnected chassis 14 in a manner discussed in further detail below.

Interior operating unit 16 includes an interior escutcheon 62, a turn piece 64, and an interior operator 66. Turn piece 64 includes a drive member 68 that engages drive member 58 of dead bolt lock assembly 19, and engages interconnected chassis 14. Turn piece 64 is rotatably coupled to interior escutcheon 62 via a snap ring 67. Interior operator 66 includes a drive portion 70, such as a split half-round spindle. Split half-round spindle 70 is permanently assembled into interior operator 66, and does not engage with half-round spindle 48 of exterior operator 18. Interior operator 66 further includes, however, a mounting portion 114, which engages interior drivers in lower cam 76.

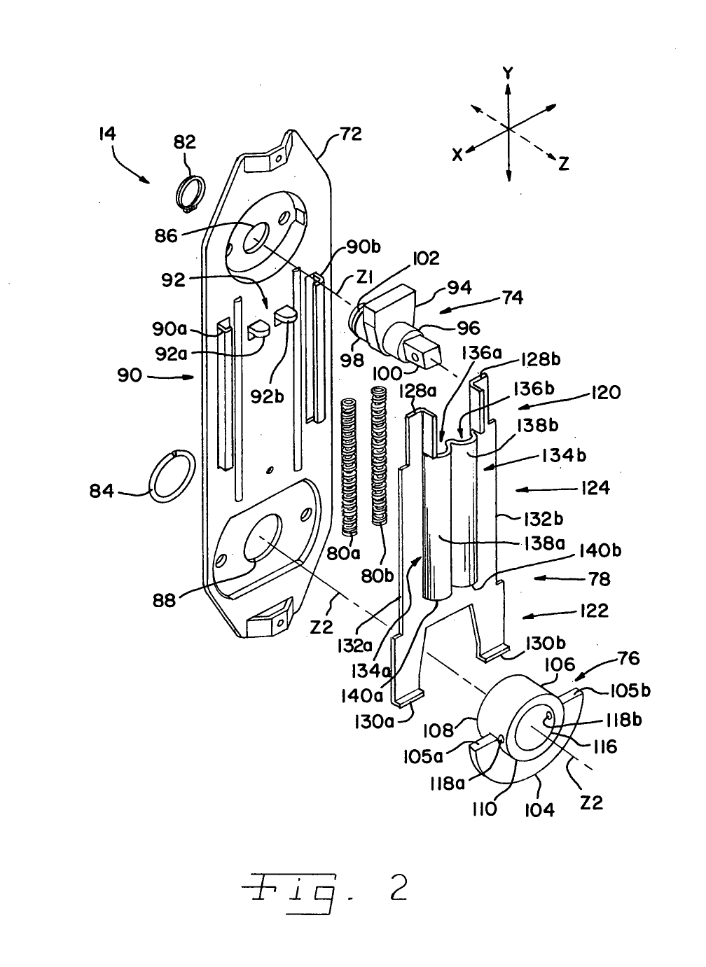

Referring now also to FIG. 2, interconnected chassis 14 is an assembly that includes a mounting plate 72, an upper cam arm 74, a lower cam arm 76, a slide plate 78, two springs 80a and 80b, a retaining ring 82 and a retaining ring 84. Interior escutcheon 62 covers interconnected chassis 14, and is mounted to door 12 via fasteners 85 that engage holes in mounting plate 72 (see FIG. 1).

Mounting plate 72 includes an upper opening 86; a lower opening 88 vertically spaced apart from upper opening 86 in direction Y; a pair of guide channels 90, individually referenced as 90a and 90b, and horizontally spaced apart in direction X; and a pair of spring engaging members 92, individually referenced as 92a and 92b, and horizontally spaced apart in direction X.

Upper cam arm 74 includes a cam lobe 94, and an axial shaft 96 having a first end portion 98 and a second end portion 100, with cam lobe 94 being fixed to axial shaft 96 between first end portion 98 and second end portion 100. First end portion 98 includes a snap-ring groove 102. During assembly, first end portion 98 is inserted through upper opening 86 of mounting plate 72, and is rotatably supported thereby. Retaining ring 82 in inserted into snap-ring groove 102 to retain upper cam arm 74 in rotatable attachment with, i.e., is rotatably coupled to, mounting plate 72. Upon final attachment of interconnected chassis 14 to door 12, second end portion 100 is connected to drive member 68 of turn piece 64, and first end portion 98 is connected to drive member 58 of dead bolt lock assembly 19. Thus, upper cam arm 74 may be rotated about its rotational axis Z1 by a corresponding rotation of either of drive member 68 of turn piece 64 or drive member 58 of dead bolt lock assembly 19.

Lower cam arm 76 includes a cam lobe 104 having cam surfaces 105a and 105b, and a hollow axial shaft 106 having a first end portion 108 and a second end portion 110, with cam lobe 104 being fixed to hollow axial shaft 106 between first end portion 108 and second end portion 110. First end portion 108 includes a snap-ring groove 112 (see FIG. 1). During assembly, first end portion 108 is inserted through lower opening 88 of mounting plate 72, and is rotatably supported thereby. Retaining ring 84 in inserted into snap-ring groove 112 to retain lower cam arm 76 in rotatable attachment with, i.e., is rotatably coupled to, mounting plate 72. Upon final attachment of interconnected chassis 14 to door 12, mounting portion 114 of interior operator 66 is received in an opening 116 of hollow axial shaft 106, and is attached and secured thereto by set screws 118a, 118b. The configuration of exterior operator 18 and interior operator 66 is such that lower cam arm 76 can be rotated about its rotational axis Z2 by a corresponding rotation of interior operator 66, but lower cam arm 76 is not operable by drive portion 48 of exterior handle 46 of exterior operator 18.

Slide plate 78 has a first end 120, a second end 122, and an interior region 124 located between first end 120 and second end 122. A pair of upper cam arm engagement members 128a, 128b is located at first end 120 of slide plate 78. A pair of lower cam arm engagement members 130a, 130b is located at second end 122 of slide plate 78.

Interior region 124 includes a pair of guide rails 132a, 132b that are horizontally spaced, i.e., spaced in the X direction, and vertically extending, i.e., extending in the Y direction. In addition, interior region 124 includes a pair of horizontally spaced, and vertically extending, spring retention housings 134a, 134b. Spring retention housing 134a includes an elongated cavity 136a defined by a spring retention wall 138a, and has a spring engaging surface 140a. Spring retention housing 134b includes an elongated cavity 136b defined by a spring retention wall 138b, and has a spring engaging surface 140b.

During assembly of interconnected chassis 14, slide plate 78 is positioned between guide channels 90a, 90b of mounting plate 72, such that guide rails 132a, 132b are in respective sliding engagement with guide channels 90a, 90b.

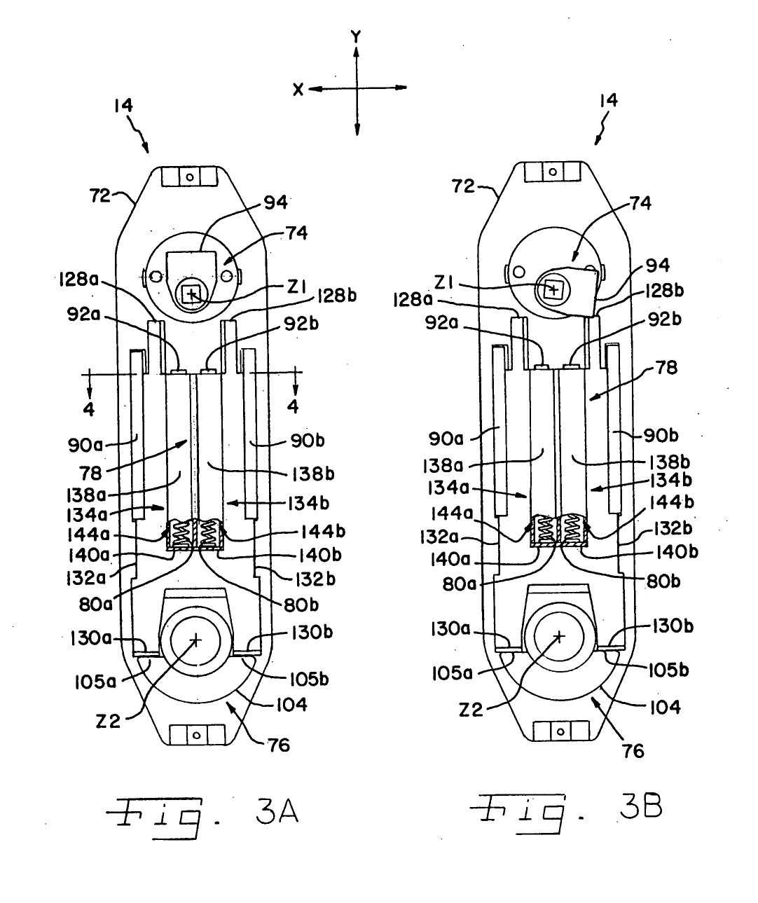

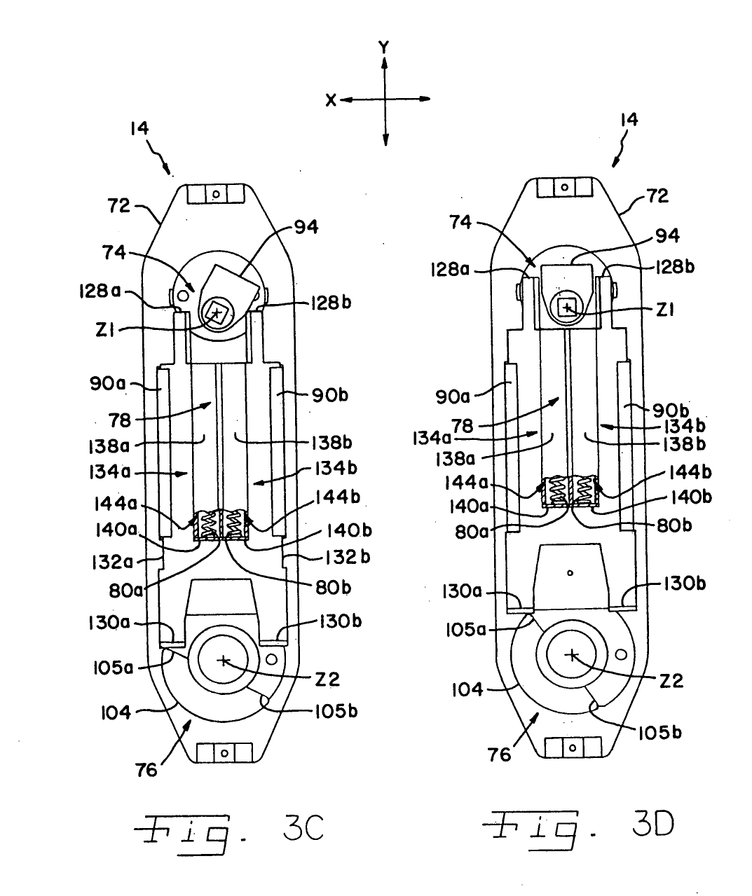

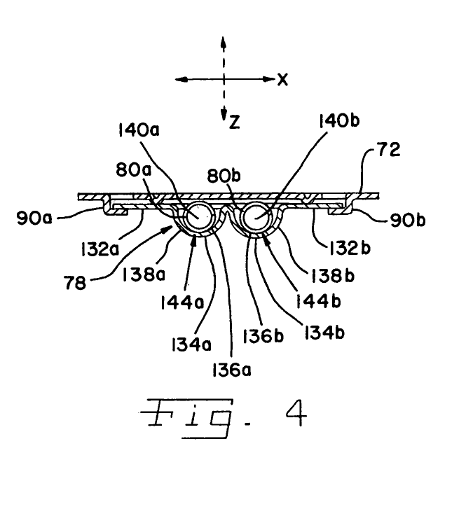

Referring to FIGS. 1, 3A and 4, elongated cavity 136a defined by spring retention wall 138a of slide plate 78 cooperates with mounting plate 72 to define an elongated spring retention chamber 144a that provides lateral containment and lateral support of compression spring 80a, e.g., in the plane of directions X and Z. Compression spring 80a is positioned in the elongated spring retention chamber 144a, and the longitudinal ends of compression spring 80a are positioned between spring engaging member 92a of mounting plate 72 and spring engaging surface 140a of spring retention housing 134a of slide plate 78, which thereby provide longitudinal retention of compression spring 80a, e.g., in direction Y. As shown in FIGS. 3A-3D, the longitudinal extent of compression spring 80a is covered by the elongated spring retention chamber 144a, although a portion of spring retention housing 134a is shown broken away to show the containment of spring 80a.

Also, elongated cavity 136b defined by spring retention wall 138b of slide plate 78 cooperates with mounting plate 72 to define an elongated spring retention chamber 144b that provides lateral containment and lateral support of compression spring 80b, e.g., in the plane of directions X and Z. Compression spring 80b is positioned in the elongated spring retention chamber 144b, and the longitudinal ends of compression spring 80b are positioned between spring engaging member 92b of mounting plate 72 and spring engaging surface 140b of spring retention housing 134b of slide plate 78, which thereby provide longitudinal retention of compression spring 80b, e.g., in direction Y. As shown in FIGS. 3A-3D, the longitudinal extent of compression spring 80b is covered by the elongated spring retention chamber 144b, although a portion of spring retention housing 134b is shown broken away to show the containment of spring 80b.

FIG. 3A is front view of interconnected chassis 14 with each of slide plate 78 and lower cam arm 76 in a rest position, and with upper cam arm 74, and correspondingly turn piece 64, in an unlocked position. The unlocked position corresponds to a position wherein the dead bolt of dead bolt assembly 20 (see FIG. 1) is retracted. With this arrangement, each of compression springs 80a, 80b bias lower cam arm engagement members 130a, 130b of slide plate 78 into engagement with cam surfaces 105a, 105b of lower cam arm 76, thus defining the respective rest positions for lower cam arm 76 and slide plate 78, when no rotational force is applied to interior operator 66 (see also FIG. 1).

FIG. 3B is a front view of interconnected chassis 14 with upper cam arm 74 in a locked position, which occurs, for example, when either turn piece 64 or drive member 58 of dead bolt lock assembly 19 is rotated approximately 90 degrees. The locked position corresponds to a position wherein the dead bolt of dead bolt assembly 20 (see FIG. 1) is extended to engage the strike of the door frame (not shown). With this arrangement, each of compression springs 80a, 80b continue to bias lower cam arm engagement members 130a, 130b of slide plate 78 into engagement with cam surfaces 105a, 105b of lower cam arm 76.

FIG. 3C is a front view of interconnected chassis 14, wherein a rotation of lower cam arm 76 causes slide plate 78 to engage and rotate the upper cam arm 74 from the locked position (see FIG. 3B) toward the unlocked position (see FIG. 3A). More specifically, also referring to FIG. 1, a counterclockwise rotation of interior operator 66 about rotational axis Z2 results in a corresponding rotation of lower cam arm 76, which in turn causes a vertical displacement of slide plate 78 in direction Y, with cam lobe 104 of lower cam arm 76 lifting slide plate 78 via continuing engagement of cam surface 105a with lower cam arm engagement member 130a of slide plate 78. In turn, upper cam arm engagement member 128b engages cam lobe 94 of upper cam arm 74, resulting in a rotation of upper cam arm 74 about rotational axis Z1. Likewise, a clockwise rotation of interior operator 66 about rotational axis Z2 results in a corresponding rotation of lower cam arm 76, which in turn causes a vertical displacement of slide plate 78 in direction Y, with cam lobe 104 of lower cam arm 76 lifting slide plate 78 via continuing engagement of cam surface 105b with lower cam arm engagement member 130b of slide plate 78. In turn, upper cam arm engagement member 128b engages cam lobe 94 of upper cam arm 74, resulting in a rotation of upper cam arm 74 about rotational axis Z1.

FIG. 3D is a front view of interconnected chassis 14 with slide plate 78 having rotated upper cam arm 74 to the unlocked position, as a continuation of the operation described above with respect to FIG. 3C. The unlocked position of FIG. 3D is achieved from the locked position of FIG. 3B when lower cam arm 76 has rotated approximately 45 degrees, via the corresponding driving rotation of interior operator 66.

When the rotational force is removed from interior operator 66, each of slide plate 78 and lower cam arm 76 return to the rest position as shown in FIG. 3A, and upper cam arm 74, and correspondingly turn piece 64, remain in the unlocked position.

While this invention has been described with respect to one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An interconnected chassis for a lock set, comprising:
a mounting plate including a first guide channel, a second guide channel spaced apart from said first guide channel, and a spring engaging member;
a lower cam arm, having a lower rotational axis, rotatably coupled to said mounting plate;
a slide plate having a spring retention wall and a spring engaging surface, said slide plate being positioned between, and in sliding engagement with, said first guide channel and said second guide channel, and positioned above said lower cam arm;
a spring; and
a spring retention chamber established between said spring retention wall of said slide plate and said mounting plate, said spring retention chamber providing lateral containment of said spring, said spring being positioned in said spring retention chamber between said spring engaging member of said mounting plate and said spring engaging surface of said slide plate.

2. The interconnected chassis of claim 1, further comprising an upper cam arm, having an upper rotational axis, rotatably coupled to said mounting plate, said upper cam arm being positioned above said slide plate.

3. The interconnected chassis of claim 2, wherein a rotation of said lower cam arm about said lower rotational axis results in a displacement of said slide plate, said displacement of said slide plate causing said slide plate to engage said upper cam arm, resulting in a rotation of said upper cam arm about said upper rotational axis.

4. A method for providing an interconnected chassis for a lock set, comprising the steps of:
configuring a mounting plate including a first guide channel, a second guide channel spaced apart from said first guide channel, and a spring engaging member;
rotatably coupling a lower cam arm, having a lower rotational axis, to said mounting plate;
configuring a slide plate having a spring retention wall and a spring engaging surface;
positioning said slide plate between, and in sliding engagement with, said first guide channel and said second guide channel, and above said lower cam arm; and
establishing a spring retention chamber between said spring retention wall of said slide plate and said mounting plate, said spring retention chamber providing lateral containment of a spring, said spring being positioned in said spring retention chamber between said spring engaging member of said mounting plate and said spring engaging surface of said slide plate.

5. The method of claim 4, further comprising the step of rotatably coupling an upper cam arm, having an upper rotational axis, to said mounting plate, said upper cam arm being positioned above said slide plate.

6. The method of claim 5, wherein a rotation of said lower cam arm about said lower rotational axis results in a displacement of said slide plate, said displacement of said slide plate causing said slide plate to engage said upper cam arm, resulting in a rotation of said upper cam arm about said upper rotational axis.

7. A lock set with an interconnected chassis, comprising:
a mounting plate including a first guide channel, a second guide channel spaced apart from said first guide channel, and a first spring engaging member;
a first cam arm, having a first rotational axis, rotatably coupled to said mounting plate;
a second cam arm, having a second rotational axis, rotatably coupled to said mounting plate, said first cam arm and said second cam arm being spaced apart;
a slide plate having a first cam arm engagement member, a second cam arm engagement member, and an interior region located between said first cam arm engagement member and said second cam arm engagement member, said interior region of said slide plate having a first spring retention wall and a first spring engaging surface, said slide plate being positioned between, and in sliding engagement with, said first guide channel and said second guide channel;
a first compression spring; and
a first spring retention chamber established between said first spring retention wall of said slide plate and said mounting plate, said first spring retention chamber providing lateral containment of said first compression spring, said first compression spring being positioned in said first spring retention chamber between said first spring engaging member of said mounting plate and said first spring engaging surface of said slide plate.

8. The lock set of claim 7, said first compression spring biasing said second cam arm engagement member of said slide plate into engagement with said second cam arm.

9. The lock set of claim 8, wherein a rotation of said second cam arm about said second rotational axis results in a displacement of said slide plate, said displacement of said slide plate causing said first cam arm engagement member of said slide plate to engage said first cam arm, resulting in a rotation of said first cam arm about said first rotational axis.

10. The lock set of claim 9, wherein said rotation of said second cam arm is effected by a corresponding rotation of an interior operator.

11. The lock set of claim 7, said first spring retention wall defining a first elongated cavity in said slide plate.

12. The lock set of claim 7, further comprising:
a second spring engaging member formed at said mounting plate and spaced apart from said first spring engaging member;
a second spring retention wall formed at said slide plate;
a second spring engaging surface formed at said slide plate;
a second compression spring; and
a second spring retention chamber established between said second spring retention wall of said slide plate and said mounting plate, said second spring retention chamber providing lateral containment of said second compression spring, said second compression spring being positioned in said second spring retention chamber between said second spring engaging member of said mounting plate and said second spring engaging surface of said slide plate.

13. The lock set of claim 12, said second spring retention wall defining a second elongated cavity in said slide plate.

14. The lock set of claim 7, further comprising:
an opening formed through said second cam arm along said second rotational axis; and
an operator having a mounting portion and a split half-round spindle, said mounting portion being positioned in said opening and attached to said second cam arm.

15. The lock set of claim 14, wherein said mounting portion is attached to said second cam arm via a set screw.

16. A method for providing a lock set with an interconnected chassis, comprising the steps of:
configuring a mounting plate for attachment to a door, said mounting plate having a first guide channel, a second guide channel spaced apart from said first guide channel, and a first spring engaging member;
rotatably coupling a first cam arm, having a first rotational axis, to said mounting plate;
rotatably coupling a second cam arm, having a second rotational axis, to said mounting plate, said first cam arm and said second cam arm being spaced apart;
forming a slide plate having a first cam arm engagement member, a second cam arm engagement member, and an interior region located between said first cam arm engagement member and said second cam arm engagement member, said interior region of said slide plate having a first spring retention wall and a first spring engaging surface;
positioning said slide plate between, and in sliding engagement with, said first guide channel and said second guide channel;
establishing a first spring retention chamber between said first spring retention wall of said slide plate and said mounting plate, said first spring retention chamber providing lateral containment of a first compression spring; and
positioning said first compression spring in said first spring retention chamber, and between said first spring engaging member of said mounting plate and said first spring engaging surface of said slide plate.

17. The method of claim 16, said first compression spring biasing said second cam arm engagement member of said slide plate into engagement with said second cam arm.

18. The method of claim 17, wherein rotating said second cam arm about said second rotational axis results in a displacement of said slide plate, said displacement of said slide plate causing said first cam arm engagement member of said slide plate to engage said first cam arm, resulting in a rotation of said first cam arm about said first rotational axis.

19. The method of claim 18, wherein said rotating of said second cam arm is effected by a corresponding rotation of an interior operator.

20. The method of claim 16, said first spring retention wall defining a first elongated cavity in said slide plate.

21. The method of claim 16, further comprising the steps of:
forming a second spring engaging member at said mounting plate and spaced apart from said first spring engaging member;
forming a second spring retention wall at said slide plate;
forming a second spring engaging surface at said slide plate; and
establishing a second spring retention chamber between said second spring retention wall of said slide plate and said mounting plate, said second spring retention chamber providing lateral containment of a second compression spring, said second compression spring being positioned in said second spring retention chamber between said second spring engaging member of said mounting plate and said second spring engaging surface of said slide plate.

22. The method of claim 21, said second spring retention wall defining a second elongated cavity in said slide plate.

23. The method of claim 16, further comprising the steps of:
forming an opening in said second cam arm along said second rotational axis; and
positioning a mounting portion of an operator having a split half-round spindle in said opening and attaching said mounting portion to said second cam arm.

24. The method of claim 23, wherein said mounting portion is attached to said second cam arm via a set screw.

25. An interconnected chassis for a lock set, comprising:
a mounting plate configured for attachment to a door, said mounting plate including a first opening and a second opening vertically spaced apart from said first opening, a first guide channel and a second guide channel horizontally spaced apart from said first guide channel, and at least a first spring engaging member;
a first cam arm having a first rotational axis, said first cam arm being rotatably coupled to said mounting plate at said first opening;
a second cam arm having a second rotational axis, said second cam arm being rotatably coupled to said mounting plate at said second opening;
a first compression spring; and
a slide plate having a first end, a second end, and an interior region between said first end and said second end, said slide plate being positioned between, and in sliding engagement with, said first guide channel and said second guide channel,
said slide plate including a first cam arm engagement member located at said first end of said slide plate and a second cam arm engagement member located at said second end of said slide plate,
said interior region of said slide plate having at least a first spring retention housing, said first spring retention housing having a first elongated cavity defined by a first spring retention wall and having a first spring engaging surface,
said first elongated cavity of said slide plate cooperating with said mounting plate to define a first spring retention chamber that provides lateral containment and support of said first compression spring, said first compression spring being positioned between said first spring engaging member of said mounting plate and said first spring engaging surface of said slide plate, said first compression spring biasing said second cam arm engagement member of said slide plate into engagement with said second cam arm.

26. The interconnected chassis of claim 25, further comprising:
said mounting plate including a second spring engaging member horizontally spaced apart from said first spring engaging member;
a second compression spring; and
said slide plate having a second spring retention housing, said second spring retention housing having a second elongated cavity defined by a second spring retention wall and having a second spring engaging surface,
said second elongated cavity of said slide plate cooperating with said mounting plate to define a second spring retention chamber that provides lateral containment and support of said second compression spring, said second compression spring being positioned between said second spring engaging member of said mounting plate and said second spring engaging surface of said slide plate, said first compression spring and said second compression spring biasing said second cam arm engagement member of said slide plate into engagement with said second cam arm.

27. The interconnected chassis of claim 25, further comprising:
an opening formed through said second cam arm along said second rotational axis; and
an operator having a mounting portion and a split half-round spindle, said mounting portion being positioned in said opening and attached to said second cam arm.

28. The interconnected chassis of claim 27, wherein said mounting portion is attached to said second cam arm via a set screw.

29. The interconnected chassis of claim 25, wherein a rotation of said second cam arm about said second rotational axis results in a displacement of said slide plate, said displacement of said slide plate causing said first cam arm engagement member of said slide plate to engage said first cam arm, resulting in a rotation of said first cam arm about said first rotational axis.

30. The interconnected chassis of claim 29, wherein said rotation of said second cam arm is effected by a corresponding rotation of an interior operator.
